(19) United States
(12) Patent Application Publication
(10) Pub. No.: US 2026/0028731 A1
(43) Pub. Date: Jan. 29, 2026

(54) MEMBRANE ELECTRODE ASSEMBLY UTILIZING STAMPED BIPOLAR PLATE ARRANGEMENT

(71) Applicant: JTEKT Bearings North America LLC, Greenville, SC (US)

(72) Inventor: Michael Franklin, Fountain Inn, SC (US)

(21) Appl. No.: 19/273,707

(22) Filed: Jul. 18, 2025

Related U.S. Application Data
(60) Provisional application No. 63/675,863, filed on Jul. 26, 2024.

(51) Int. Cl. C25B 11/036; B21D 22/02; C25B 9/23; C25B 9/75; C25B 9/77; H01M 8/0206; H01M 8/0256; H01M 8/0258; H01M 8/10; H01M 8/1004; H01M 8/241; H01M 8/248

(52) U.S. Cl. CPC C25B 11/036; B21D 22/02; C25B 9/23; C25B 9/75; C25B 9/77; H01M 8/0206; H01M 8/0256; H01M 8/0258; H01M 8/1004; H01M 8/241; H01M 8/248; H01M 2008/1095

(57) ABSTRACT

A bipolar plate arrangement comprises a first plate portion and a separate second plate portion juxtaposed and connected to one another, the first plate portion and the second plate portion defining a plurality of aligned port apertures. An inner seal is positioned between the first plate portion and the second plate portion, the inner seal, the first plate portion, and the second plate portion together defining a plurality of fluid passages providing fluid communication between the port apertures and a corresponding fluid aperture defined in one of the first plate portion or the second plate portion.

### CROSS-REFERENCE TO A RELATED APPLICATION

This application is based upon and claims the benefit of U.S. provisional patent application No. 63/675,863, filed Jul. 26, 2024, which is incorporated herein by reference in its entirety for all purposes.

### FIELD OF THE INVENTION

The present invention relates to membrane electrode assemblies using bipolar plates, such as are used in electrolyzers and fuel cells.

### BACKGROUND OF THE INVENTION

Membrane electrode assemblies (MEAs) using bipolar plates sandwiching a proton exchange membrane (PEM) are known. Typically, multiple MEAs are stacked next to each other to provide a series connection with each MEA providing a portion of the overall voltage drop (in an electrolyzer) or contributing a portion of the total voltage output (in a fuel cell). The bipolar plates serve as flat separator plates and need to have low electrical resistance with high mechanical and chemical stability, effective fluid distribution, and high thermal conductivity.

Bipolar plates are typically machined from metal plate. Machined plates, however, are expensive, difficult to make, lead to wasted material, and are often heavier than desired.

Electrolyzers use electricity to split water or other components into their constituent elements through electrolysis. For example, an electrolyzer may be used to split water into oxygen (O₂) and hydrogen (H₂). In one application, the hydrogen can be stored and then later used to generate electricity in a fuel cell. Thus, the hydrogen in a sense stores electricity generated during times of excess generation capacity to be used later when generation capacity is otherwise decreased.

The present invention recognizes and addresses considerations of prior art constructions and methods.

### SUMMARY OF THE INVENTION

According to one aspect, the present invention provides a bipolar plate arrangement comprising a first plate portion and a separate second plate portion juxtaposed and connected to one another, the first plate portion and the second plate portion defining a plurality of aligned port apertures. An inner seal is positioned between the first plate portion and the second plate portion. The inner seal, the first plate portion, and the second plate portion together define a plurality of fluid passages providing fluid communication between the port apertures and a corresponding fluid aperture defined in one of the first plate portion or the second plate portion.

In some exemplary embodiments, the bipolar plate arrangement comprises a plurality of aligned connection apertures defined in the first plate portion and the second plate portion. A plurality of grommets may respectively extend through the aligned connection apertures to fasten the first plate portion and the second plate portion together. For example, each of the grommets may be formed of a resilient material. Moreover, the grommets may each be configured having a cylindrical portion with larger diameter head portions at the respective ends thereof. At least some of the grommets may define an axial aperture extending therethrough.

In some exemplary embodiments, a gasket may be located on an outer surface of at least one of the first plate portion or the second plate portion.

In some exemplary embodiments, the plurality of aligned port apertures may comprise at least three port apertures defined in the first plate portion respectively aligned with a corresponding port aperture of at least three port apertures defined in the second plate portion to yield at least three fluid ports. In this regard, two of the at least three fluid ports may be in respective fluid communication with first and second flow apertures defined in the first plate portion and one of the at least three fluid ports may be in fluid communication with a third flow aperture defined in the second plate portion.

In some exemplary embodiments, each of the first plate portion and the second plate portion may be formed by stamping.

A further aspect of the present invention provides an apparatus comprising a plurality of bipolar plates arranged in a stack, the bipolar plates each comprising a first plate portion and a separate second plate portion connected to one another by grommets, the first plate portion and the second plate portion defining a plurality of aligned port apertures. A plurality of proton exchange membranes are respectively sandwiched between adjacent bipolar plates. A first compression plate is located at a first end of the stack and a second compression plate is located at a second end of the stack.

In some exemplary embodiments, the grommets of adjacent ones of the bipolar plates axially engage each other. A plurality of tie rods may respectively extend through aligned axial apertures in at least some of the grommets.

A still further aspect of the present invention provides a method of fabricating a bipolar plate arrangement. One step of the method involves providing metal in sheet form. According to another step, the metal is stamped progressively to yield a first plate portion and a second plate portion. The first plate portion is connected to the second plate portion in a back-to back manner.

The accompanying drawings, which are incorporated in and constitute a part of this specification, illustrate one or more embodiments of the disclosure and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a simplified diagrammatic representation of an electrolyzer device in accordance with an embodiment of the present invention.

FIG. 2 is a diagrammatic view of an electrolyzer device in accordance with an embodiment of the present invention, with components separated for purposes of illustration.

FIG. 3 is a top perspective view of a bipolar plate arrangement formed from two half plates in accordance with an embodiment of the present invention showing the “water side.”

FIG. 4 is an exploded perspective view of the bipolar plate of FIG. 3 showing the two half plates and other components.

FIG. 5 is an enlarged perspective cross section of a grommet of the bipolar plate serving to hold the two half plates together.

FIG. 6 is a top cross-sectional perspective view of the bipolar plate of FIG. 3 primarily showing the “water side.”

FIG. 7 is a top perspective view showing a quarter of the overall bipolar plate in cross section.

FIG. 8 is a bottom cross-sectional perspective view of the bipolar plate of FIG. 3 primarily showing the “hydrogen side.”

FIG. 9 is a perspective view showing a stack of three bipolar plates constructed in accordance with an embodiment of the present invention.

FIG. 10 is an exploded perspective view of the stack of FIG. 9.

FIG. 11 is a perspective cross-sectional view through axially-aligned grommets of the stack of FIG. 9.

FIG. 12 is a top perspective cross-sectional view of the stack of FIG. 9.

FIG. 13 is a bottom perspective cross-sectional view of the stack of FIG. 9.

Repeat use of reference characters in the present specification and drawings is intended to represent same or analogous features or elements of the invention according to the disclosure.

### DETAILED DESCRIPTION OF PREFERRED EMBODIMENTS

Reference will now be made in detail to presently preferred embodiments and presently preferred methodology of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment (or method) may be used on another embodiment (or method) to yield a still further embodiment (or method). Thus, it is intended that the present invention covers such modifications and variations as come within the scope of the appended claims and their equivalents.

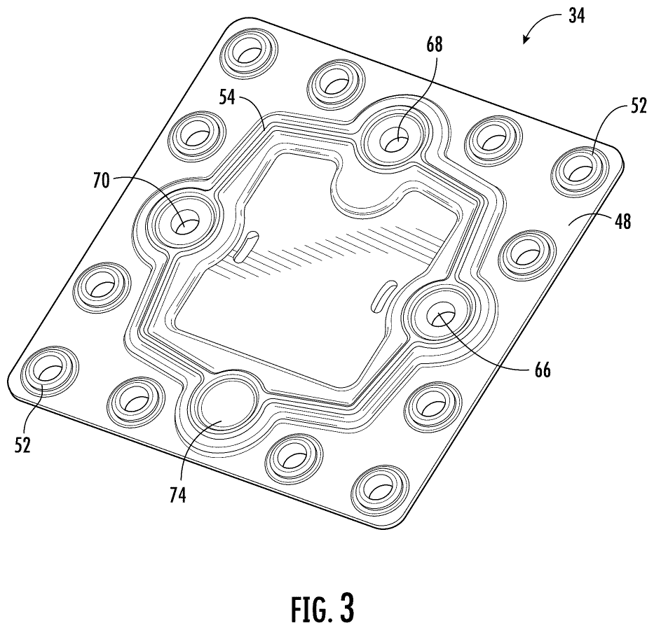

As used herein, terms referring to a direction or a position of the bipolar plate arrangement, such as but not limited to “vertical,” “horizontal,” “top,” “bottom,” “above,” or “below,” refer to directions and relative positions with the bipolar plate's “water side” shown in FIG. 3 being considered the top. Further, the term “or” as used in this document is intended to mean an inclusive “or” rather than an exclusive “or.” That is, unless specified otherwise, or clear from the context, the phrase “X employs A or B” is intended to mean any of the natural inclusive permutations. Therefore, the phrase “X employs A or B” is satisfied by any of the following instances: X employs A; X employs B; or X employs both A and B. In addition, the articles “a,” “an,” and “the” as used in this document should generally be construed to mean “one or more” unless specified otherwise or clear from the context to be directed solely to a singular form. The meaning of “in” may include “in” and “on.” The word “at” may include “at,” “adjacent to,” and “on.” The phrase “in one embodiment,” as used herein does not necessarily refer to the same embodiment, although it may. The meanings identified above do not necessarily limit the terms, but merely provide illustrative examples for the terms.

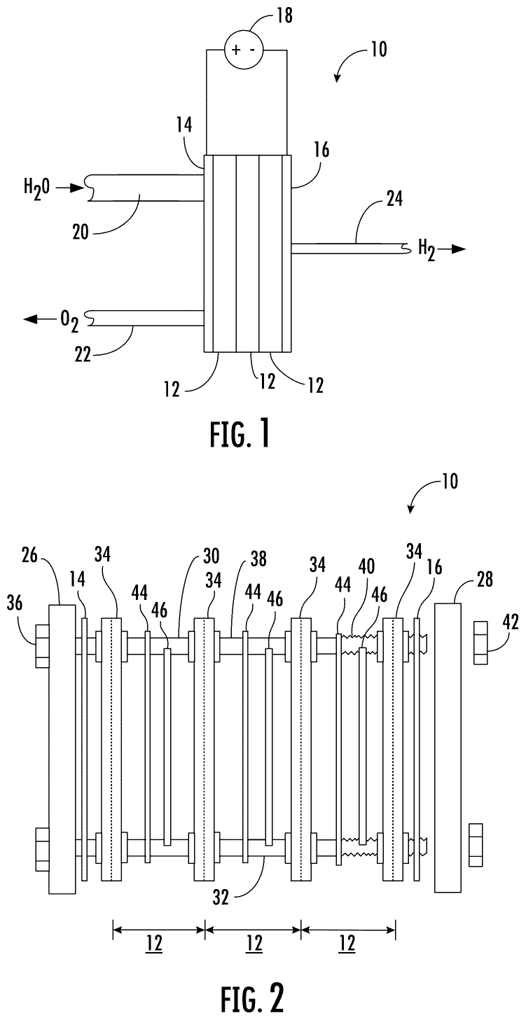

FIG. 1 illustrates an electrolyzer device 10 constructed in accordance with an embodiment of the present invention. Device 10 includes a plurality of MEAs 12 arranged in a stack between an anode 14 and a cathode 16. A DC power supply 18 applies source potential across anode 14 and cathode 16, such that each of the MEAs 12 has a divided voltage drop across it summing to the source potential. Operation of electrolyzer device 10 causes water introduced at port 20 to be split into oxygen and hydrogen, which can be respectively collected at ports 22 and 24. While only three MEAs 12 are stacked together in this example, one skilled in the art will appreciate that the electrolyzer device 10 may typically have many more such MEAs.

Certain additional details of electrolyzer device 10 can be most easily explained with reference to FIG. 2. The MEAs 12 are held together by compression plates 26 and 28 at each end of the overall assembly. Tie rods, such as those illustrated at 30 and 32, extend through aligned holes in plates 26 and 28, as well as holes in the bipolar plates 34. The tie rods may each be in the form of a long bolt having an enlarged hexagonal head (e.g., head 36) at one end of an elongate shank (e.g., shank 38). The shank may have a threaded portion (e.g., threaded portion 40) at its distal end to receive a nut (e.g., nut 42). The nuts are tightened in a manner that uniformly compresses the stack.

Each of the bipolar plates 34 has a first side and a second side facing the anode 14 and cathode 16, respectively, which will be referred to herein as the “water side” and the “hydrogen side” (represented by the dashed line). Thus, to form three MEAs as shown in this example, a total of four bipolar plates 34 are required. In this illustration, the water side of the leftmost bipolar plate 34 will be in electrical communication with anode 14 while the hydrogen side of the rightmost bipolar plate 34 will be in electrical communication with the cathode 16. The space between two bipolar plates 34 contains a suitable gasket 44 and a PEM 46 (or other suitable ion exchange material). As will be described herein, the gasket 44 may be carried by one of the bipolar plates 34. One skilled in the art will also appreciate that, if necessary, respective insulative layers may be provided to electrically separate the anode 14 from compression plate 26 and cathode 16 from compression plate 28.

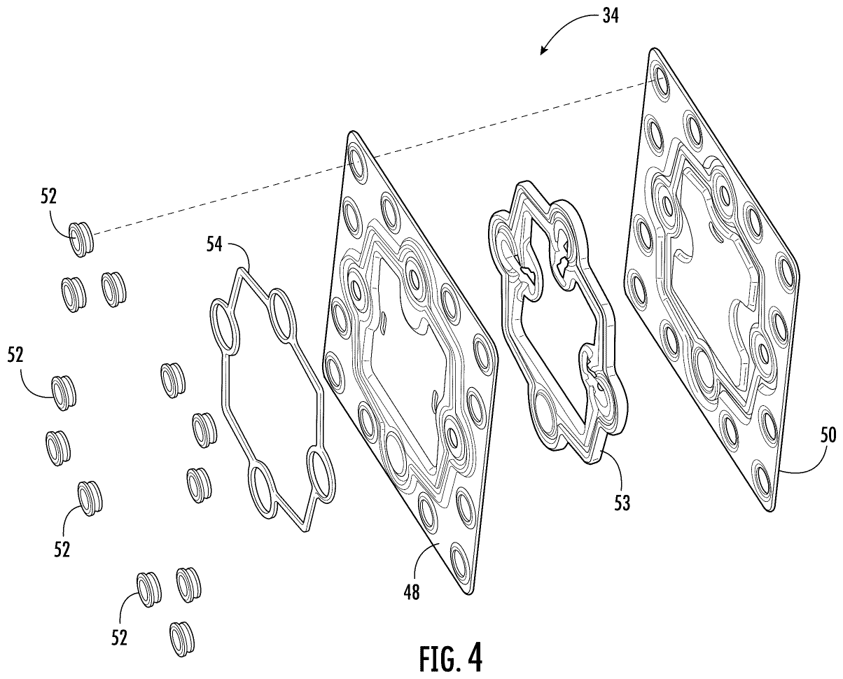

Referring now to FIGS. 3 and 4, each bipolar plate 34 comprises an arrangement of multiple components assembled together. In this regard, first and second plate portions (or “half plates”) 48 and 50 are suitably connected together in a “back-to-back” manner. In this embodiment, for example, a plurality of grommets 52 are used to fasten the half plates 48 and 50 together. An inner seal 53 is sandwiched in this embodiment between the half plates 48 and 50. A gasket 54 (corresponding to gasket 44) is seated in a corresponding groove in the outer surface of half plate 48. As used herein, the term “plate portion” refers to each of two or more separate plate elements that are themselves plate-like but configured to be connected together to yield the overall bipolar plate arrangement. In presently preferred embodiments, they may alternatively be referred to as “half plates” because there are two of them in each bipolar plate.

Half plates 48 and 50 are each formed by a stamping process in this embodiment. Such a process may begin with a coil of thin metal which is stamped progressively to form the desired features. For example, the half plates may be formed from stainless steel or titanium in some preferred embodiments. After forming, the half plates may be typically coated with a material that minimizes corrosion on plate surfaces and/or enhances electrical conductivity. The thickness of the metal may typically range from about 0.10-0.60 mm but is not limited to this range. Apertures in the plates can simply be punched out. Water and hydrogen flow through the stack may be configured and optimized via the plate geometry. Such a stamping process may have many advantages in comparison with machining typical of the prior art, including reduced material waste, higher productions rates, and lower weight. Certain features impossible to produce by machining may be possible to form by stamping. The design is also easily scalable for larger or smaller plates.

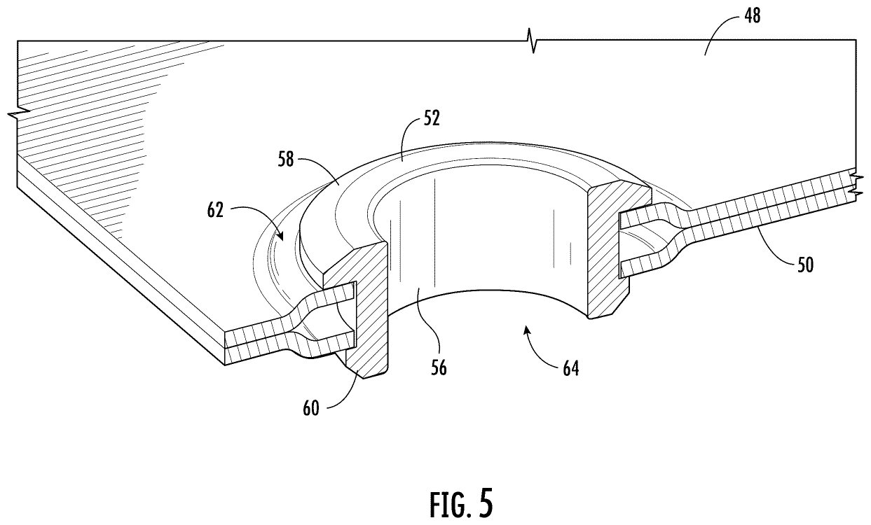

As noted above, the half plates 48 and 50 are connected together in this embodiment utilizing a plurality of grommets 52. Referring now to FIG. 5, grommet 52 may be formed of any suitable material and by any suitable method (e.g., stamped, machined, 3D printed, etc.). As can be seen, grommet 52 is formed in this case having a substantially cylindrical portion 56 with larger diameter heads 58 and 60 at each of its ends. The outer diameter of head 58 may be larger than that of head 60, as shown. As a result, grommet 52 may be installed by inserting head 60 through aligned connection apertures in half plates 58 and 60. Preferably, grommet 52 may be formed of a resilient material (e.g., an electrically conductive resilient material) that allows deformation during insertion, but which assumes its original configuration after insertion so that grommet 52 remains in place. The area of half plates 48 and 50 around the aligned apertures may be rimmed, as indicated at 62, so that grommet 52 acts as a spring tending to pull the plates together. Heat dissipation is believed to be enhanced by the natural geometry of the joined plates.

The tie rods may respectively pass through the axial aperture 64 defined by at least some of the grommets 52. In this case, the tie rods have a cylindrical cross-section in the transverse direction, so the apertures 52 are cylindrical as well. It will be appreciated that, in some embodiments, it may be desirable to use tie rods having shanks of other cross-sections. In such embodiments, the shape of the grommet (or at least the shape of the aperture 64) may be modified to match. Grommet fastening thus provides a means of aligning the bipolar plates in the stack while also providing compression control. While grommet fastening is shown, embodiments are contemplated in which other techniques of joining the half plates together are used, such as welding (e.g., laser welding), forming, pressing, hemming, etc., in addition to or instead of grommets.

Referring again to FIG. 3, bipolar plate 34 defines three ports 66, 68, and 70 spaced apart from each other. In this case, for example, the ports 66 and 68 are separated by approximately ninety degrees, as are ports 68 and 70. A fourth location 74 is not used as a port in this case, but optionally could form an additional port as necessary or desired. Water enters port 66, while hydrogen and oxygen respectively exit ports 68 and 70.

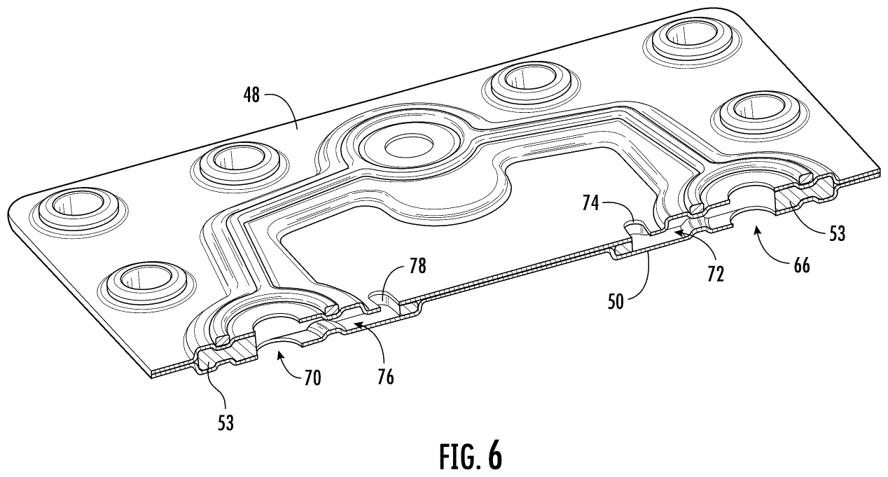

In this embodiment, inner seal 53 distributes fluid to/from the associated port to the region between adjacent bipolar plates where the PEM 46 is located. For example, as shown in FIG. 6, inner seal 53 defines, in combination with the configuration of half plates 48 and 50, a passage 72 from port 66 to a water inlet 74 in the form of an aperture defined in plate 48. Similarly, a passage 76 provides fluid communication between an oxygen outlet 78 defined in plate 48 and the port 70.

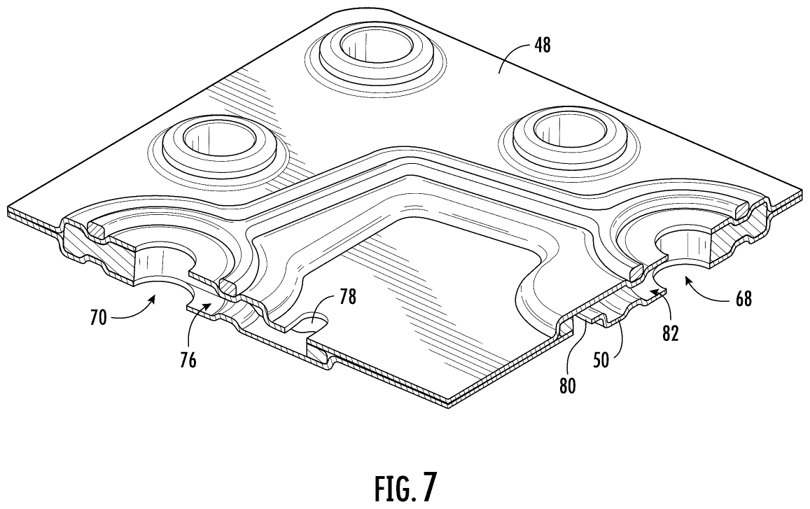

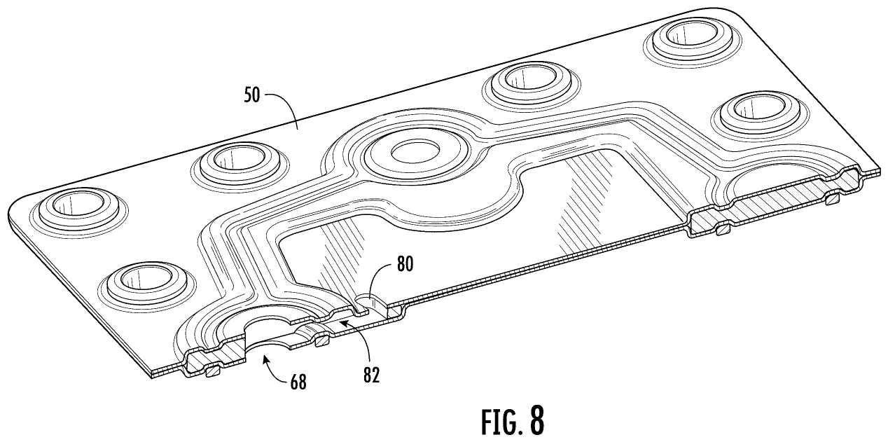

Referring now to FIGS. 7 and 8, plate 50 defines an outlet 80 for hydrogen that passes through the PEM 46. Outlet 80 is in fluid communication with port 68 via a passage 82 defined by the inner seal 53 in combination with the configuration of half plates 48 and 50.

Embodiments are contemplated that do not require an inner seal because the passages are entirely formed by configurations of the half plates.

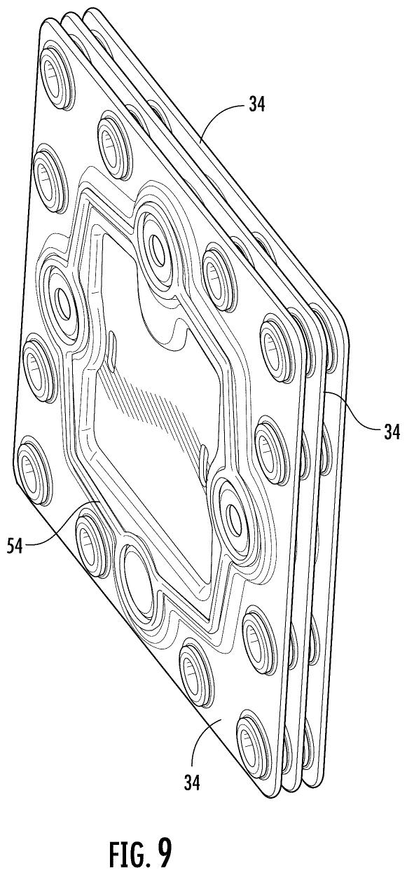

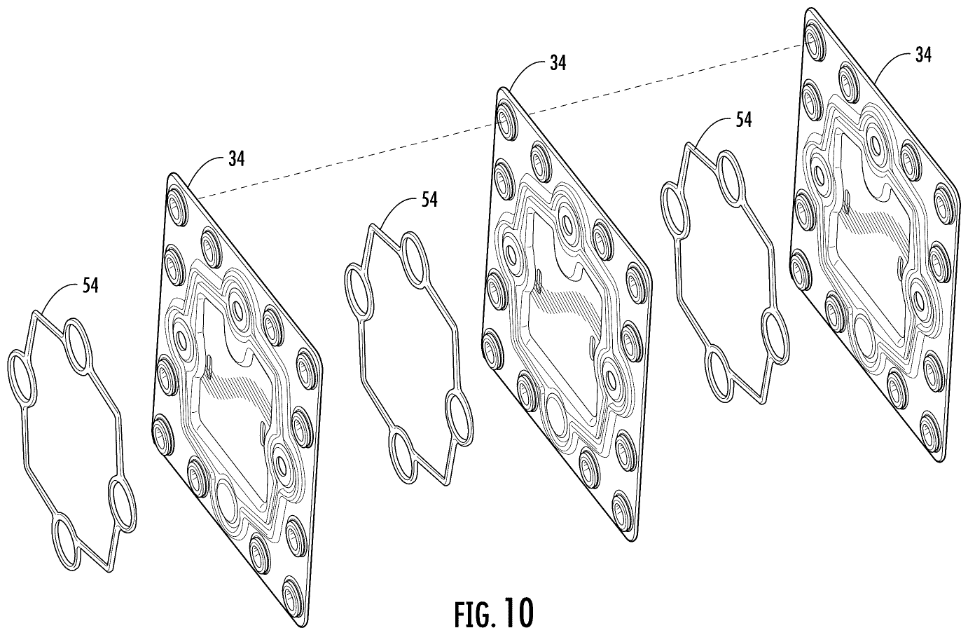

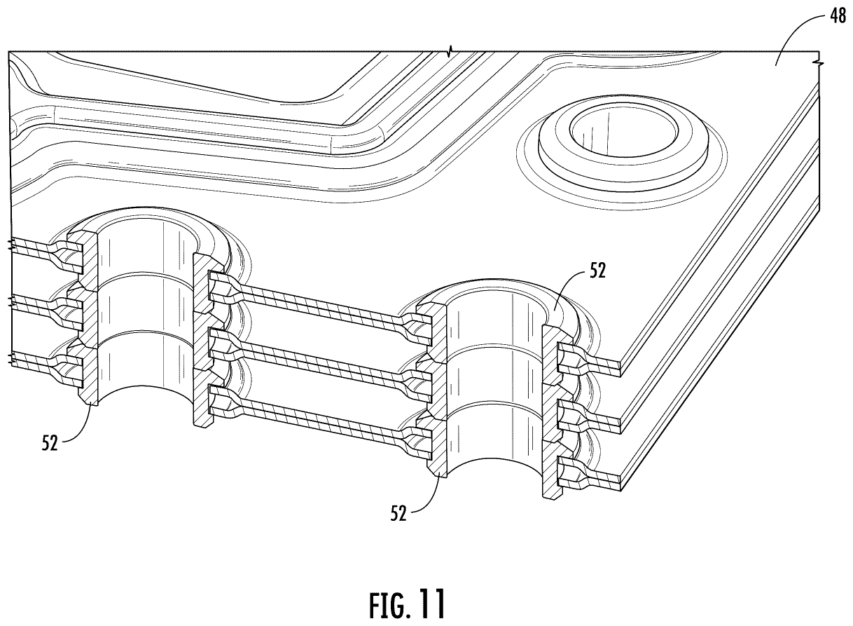

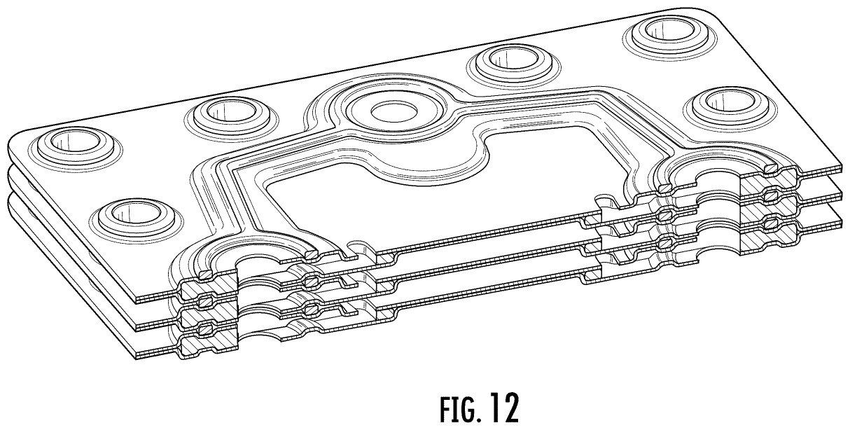

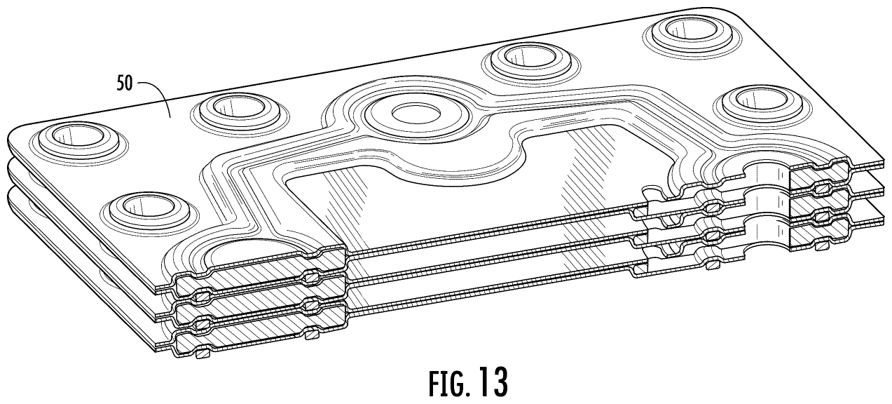

FIGS. 9 through 13 show three bipolar plates 34 in combination. As can be seen, various features such as grommets 52 (FIG. 11) align as the plates are stacked. Note that the stacked grommets desirably provide compression control. Gasket 54 of the water side of one bipolar plate 34 engages the hydrogen side of an adjacent bipolar plate 34 so as to surround and isolate the ports from the PEM 46. Gasket 54 may be formed by any suitable method, such as molding, 3D printing, etc.

While one or more preferred embodiments of the invention are described above, it should be appreciated by those skilled in the art that various modifications and variations can be made in the present invention without departing from the scope and spirit thereof.

I claim:

1. A bipolar plate arrangement comprising:
a first plate portion and a separate second plate portion juxtaposed and connected to one another, the first plate portion and the second plate portion defining a plurality of aligned port apertures; and
an inner seal positioned between the first plate portion and the second plate portion, the inner seal, the first plate portion, and the second plate portion together defining a plurality of fluid passages providing fluid communication between the port apertures and a corresponding fluid aperture defined in one of the first plate portion or the second plate portion.

2. A bipolar plate arrangement as set forth in claim 1, further comprising a plurality of aligned connection apertures defined in the first plate portion and the second plate portion.

3. A bipolar plate arrangement as set forth in claim 2, further comprising a plurality of grommets, the grommets respectively extending through the aligned connection apertures to fasten the first plate portion and the second plate portion together.

4. A bipolar plate arrangement as set forth in claim 3, wherein each of the grommets are formed of a resilient material.

5. A bipolar plate arrangement as set forth in claim 4, wherein the resilient material comprises an electrically conductive resilient material.

6. A bipolar plate arrangement as set forth in claim 4, wherein the grommets are each configured having a cylindrical portion with larger diameter head portions at the respective ends thereof.

7. A bipolar plate arrangement as set forth in claim 6, wherein at least some of the grommets define an axial aperture extending therethrough.

8. A bipolar plate arrangement as set forth in claim 1, further comprising a gasket on an outer surface of at least one of the first plate portion or the second plate portion.

9. A bipolar plate arrangement as set forth in claim 1, wherein the plurality of aligned port apertures comprises at least three port apertures defined in the first plate portion respectively aligned with a corresponding port aperture of at least three port apertures defined in the second plate portion to yield at least three fluid ports.

10. A bipolar plate arrangement as set forth in claim 9, wherein:
two of the at least three fluid ports are in respective fluid communication with first and second flow apertures defined in the first plate portion; and
one of the at least three fluid ports is in fluid communication with a third flow aperture defined in the second plate portion.

11. A bipolar plate arrangement as set forth in claim 1, wherein each of the first plate portion and the second plate portion are formed by stamping.

12. An apparatus comprising:
a plurality of bipolar plates arranged in a stack, the bipolar plates each comprising a first plate portion and a separate second plate portion connected to one another by grommets, the first plate portion and the second plate portion defining a plurality of aligned port apertures; and
a plurality of proton exchange membranes respectively sandwiched between adjacent bipolar plates; and
a first compression plate at a first end of the stack and a second compression plate at a second end of the stack.

13. An apparatus as set forth in claim 12, wherein the grommets of adjacent ones of the bipolar plates axially engage each other.

14. An apparatus as set forth in claim 13, wherein at least some of the grommets define an axial aperture extending therethrough.

15. An apparatus as set forth in claim 14, wherein a plurality of tie rods respectively extend through aligned axial apertures of the grommets.

16. An apparatus as set forth in claim 12, wherein the grommets comprise an electrically conductive material.

17. A method of fabricating a bipolar plate arrangement, the method comprising steps of:
providing metal in sheet form;
stamping the metal progressively to yield a first plate portion and a second plate portion; and
connecting the first plate portion to the second plate portion in a back-to back manner.

18. A method as set forth in claim 17, further comprising the step of situating an inner seal between the first plate portion and the second plate portion.

19. A method as set forth in claim 17, wherein the first plate portion and the second plate portion are connected together using a plurality of resilient grommets.

20. A method as set forth in claim 17, wherein the step of providing the metal in sheet form comprises unrolling the metal from a rolled coil of the metal.
